(19) United States
(12) Patent Application Publication
(10) Pub. No.: US 2008/0204382 A1
(43) Pub. Date: Aug. 28, 2008

(54) COLOR MANAGEMENT CONTROLLER FOR CONSTANT COLOR POINT IN A FIELD SEQUENTIAL LIGHTING SYSTEM

(76) Inventors: Kevin Len Li Lim, Perak (MY); Joon Chok Lee, Sarawak (MY); Boon Keat Tan, Penang (MY)

Correspondence Address: Kathy Manke;Avago Technologies Limited, 4380 Ziegler Road, Fort Collins, CO, 80525, US

(21) Appl. No.: 11/678,230

(22) Filed: Feb. 23, 2007

(51) Int. Cl. G09G 3/32

(52) U.S. Cl. 345/83

(57) ABSTRACT

A color management system for a field sequential lighting system. The color management system includes a plurality of light sources, a driver circuit, and a controller. The driver circuit is coupled to the plurality of light sources, and the controller is coupled to the driver circuit. The driver circuit drives the plurality of light sources. The controller generates first and second control signals for a first subframe of a temporal sequence of subframes. The first control signal corresponds to a first light source of a first color which is a primary color for the first subframe. The second control signal corresponds to a second light source of a second color which is a supplemental color for the first subframe. Embodiments of the color management system maintain a color point of the primary color of each subframe.

### BACKGROUND OF THE INVENTION

In conventional field sequential drive systems which use light emitting diodes (LEDs), two or more LEDs are driven in a sequence during the time period of a frame. In order to individually drive the different colors within a frame, the frame is subdivided into subframes. Each subframe corresponds to a color. Thus, each frame has as many subframes as the system has different colors. For example, in a system that uses red, green, and blue (RGB) LEDs, there are three subframes within each frame to accommodate each of the three colors. Each color corresponds to a subframe. In particular, the red LEDs are driven during one subframe, the green LEDs are driven during another subframe, and the blue LEDs are driven during the remaining subframe. Only one color is driven during each subframe.

If the combined light output is optically homogenized, and the driving frequency is above a critical frequency, then the human vision system does not differentiate among the distinct elemental LED light sources. In other words, the human vision system perceives a single light source producing a single color. The perceived color is a combination of the driven colors. For example, if red, blue, and green are all driven in sequence, the human vision system may perceive the color white, or some variation thereof.

Unfortunately, this type of system can be instable because the LED light sources are typically unstable over nominal electrical and temperature conditions. Any shift in color or brightness of the elemental LED light source during a subframe results in a shift of the perceived color of the combined light output.

This problem is manifest in a field sequential (FS) liquid crystal display (LCD) which uses RGB LEDs. Typically, each image frame of a conventional FS-LCD includes three subframes. In each subframe, only one color LED is driven, or lit up. For example, in the red LED subframe, only the red LEDs are driven, and the liquid crystal element of each pixel further modulates this red light on a per pixel basis. The same action is performed for the green and blue LEDs in sequence. In other words, each pixel modulates the red, green, and blue primary colors on a per pixel basis using liquid crystal technology. As explained above, individual shifts in the color of the red, green, or blue primary colors results in perceived color shifts for the sequentially combined color combination for each pixel.

### SUMMARY OF THE INVENTION

Embodiments of a system are described. In one embodiment, the system is a color management system for a field sequential lighting system. The color management system includes a plurality of light sources, a driver circuit, and a controller. The driver circuit is coupled to the plurality of light sources, and the controller is coupled to the driver circuit. The driver circuit drives the plurality of light sources. The controller generates first and second control signals for a first subframe of a temporal sequence of subframes. The first control signal corresponds to a first light source of a first color which is a primary color for the first subframe. The second control signal corresponds to a second light source of a second color which is a supplemental color for the first subframe. Embodiments of the color management system maintain a color point of the primary color of each subframe. Other embodiments of the system are also described.

Embodiments of an apparatus are also described. In one embodiment, the apparatus is a color management controller for a field sequential lighting system. The color management controller includes a signal generator circuit, an optical feedback circuit, and a control circuit. The signal generator circuit generates a plurality of supply signals for a plurality of light sources having a plurality of colors. The optical feedback circuit generates an optical feedback signal based on at least one sensor signal corresponding to at least one of the plurality of colors. The control circuit is coupled between the signal generator circuit and the optical feedback circuit. The control circuit implements color mixing of at least two colors of the plurality of colors during each subframe according to a color processing algorithm. Other embodiments of the apparatus are also described.

Embodiments of a method are also described. In one embodiment, the method is a method for maintaining a constant color point for a color in a field sequential lighting system. The method includes generating a primary light signal from a first light source during substantially all of a first subframe, generating a first supplemental light signal from a second light source during a first fraction of the first subframe, and generating a second supplemental light signal from a third light source during a second fraction of the first subframe. The method also includes mixing the primary light signal, the first supplemental light signal, and the second supplemental light signal to generate a pseudo-primary color during the first subframe. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic circuit diagram of one embodiment of a color management system.

FIG. 2 depicts a schematic diagram of one embodiment of a color management system controller for a field sequential lighting system.

FIG. 3 depicts a wave diagram of LED drive signals to drive LEDs in a temporal sequence for a field sequential lighting system.

FIG. 4A depicts a wave diagram of LED drive signals to drive LEDs to maintain a color point of a primary color in a field sequential lighting system.

FIG. 4B depicts another wave diagram of LED drive signals to drive LEDs to maintain a color point of a primary color in a field sequential lighting system.

FIG. 4C depicts another wave diagram of LED drive signals to drive LEDs to maintain a color point of a primary color in a field sequential lighting system.

FIG. 5 depicts one embodiment of a color management method to maintain a color point during a subframe for a field sequential lighting system.

FIG. 6 depicts a schematic diagram of another embodiment of a color management system.

FIG. 7 depicts one embodiment of a video projector which implements field sequential lighting.

FIG. 8 depicts one embodiment of a LED-based video projection wall which implements field sequential lighting.

Throughout the description, similar reference numbers may be used to identify similar elements.

### DETAILED DESCRIPTION

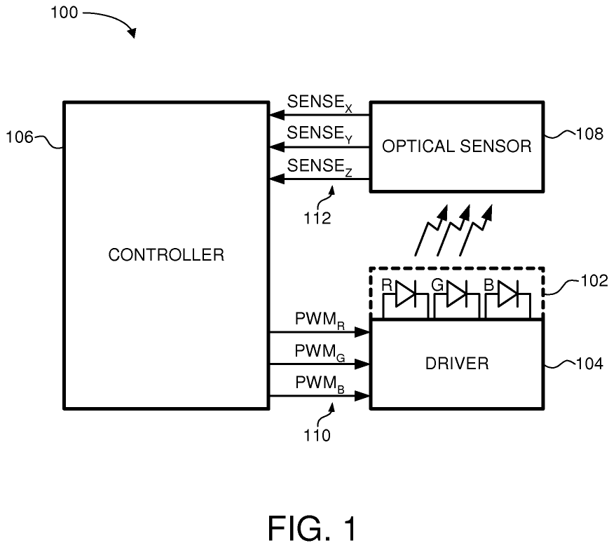

FIG. 1 depicts a schematic circuit diagram of one embodiment of a color management system 100. The illustrated color management system 100 includes a plurality of light sources 102, a driver circuit 104, a controller 106, and an optical sensor 108. Embodiments of the color management system 100 may be implemented in various applications. One application in which the color management system 100 may be implemented is a field sequential (FS) liquid crystal display (LCD).

In one embodiment, the plurality of light sources 102 includes multiple light emitting diodes (LEDs). However, other embodiments may use other types of light sources 102. For example, some embodiments use lasers, instead of LEDs. For convenience, references herein to LEDs are understood as an exemplary embodiment of the light sources 102, and the descriptions of such exemplary embodiments may be applicable to other embodiments which use other types of light sources 102.

The LEDs 102 include different colors of LEDs. For example, the LEDs 102 may include red, green, and blue (RGB) LEDs. Each color can be produced by a single LED 102 or a group (e.g., array) of LEDs 102. RGB LEDs 102 may be implemented in order to produce white light, in some instances, when the red, green, and blue lights are combined. It should be noted that the light signals from the various LEDs 102 may be combined in at least two ways. First, the light signals from the LEDs 102 may be combined by simultaneously driving the LEDs 102. Second, the light signals may be combined by driving the LEDs 102 at separate times, but sequentially at a frequency that is above a critical frequency at which a human visual system might distinguish between the separate colors. In other words, the light signals are produced in a sequence, one after the other, so quickly that the human visual system combines the individual colors to perceive a resultant combined color, despite the fact that the colors are not actually mixed at any instant in time. Conventional FS-LCD systems use this second, sequential, technique for creating the perception of color mixing.

The driver circuit 104 includes circuitry to facilitate driving the LEDs 102. In implementations which use LEDs 102, the driver circuit 104 may include current-limiting resistors in a manner that is known. In implementations which use other types of light sources 102, the driver circuit 104 may be embodied by other types of analog or digital circuitry. The driver circuit 104 receives one or more supply signals 110 from the controller 106. In some embodiments, the supply signals 110 determine the color and brightness of the LEDs 102. Where LEDs 102 are used, the supply signals 110 may be pulse-width-modulated (PWM) signals. For example, the PWM signals 110 may include a PWM_{R} signal for the red LEDs 102, a PWM_{G} signal for the green LEDs 102, and a PWM_{B} signal for the blue LEDs 102.

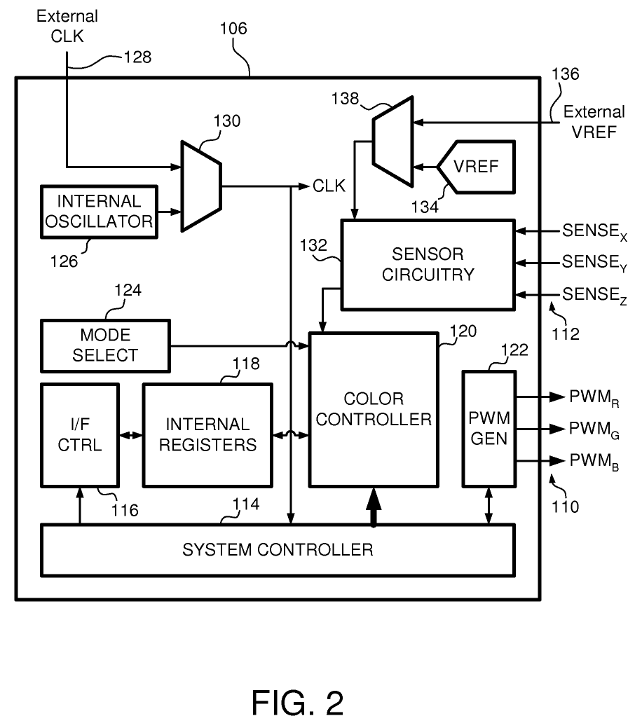

The controller 106 uses the supply signals 110 to control the proportion of light from each of the different colors of the LEDs 102. In one embodiment, the controller 106 uses one or more color processing algorithms to generate the supply signals 110. A more detailed illustration and explanation of an embodiment of the controller 106 is provided in FIG. 2 and the accompanying description.

The optical sensor 108 senses the light signals from the LEDs 102 and provides one or more sensor signals 112 to the controller 106. In this way, the optical sensor 108 provides optical feedback to the controller 108. In one embodiment, the optical sensor 108 samples individual components (i.e., RGB) of the mixed light signal produced by the LEDs 102. The optical sensor 108 may send these sampled sensor signals 112 to the controller 106 as either analog or digital signals. As an example, the optical sensor 108 is a color sensor with three channels to detect three different colors, e.g., channel X detects the red light signal component and produces the SENSE_{X} signal, channel Y detects the green light signal component and produces the SENSE_{Y} signal, and channel Z detects the blue light signal component and produces the SENSE_{Z} signal. It should be noted that other embodiments may use other color and lighting conventions, instead of RGB and XYZ.

Upon receiving the optical feedback signals 112 from the optical sensor 108, the controller 106 may modify one or more of the supply signals 110 to the driver 104. In this way, the controller 106 controls the light sources 102 to determine the resultant color of the combined light signals. In one embodiment, the controller 106 and optical sensor 108 may be calibrated to a known color correlation. The correlation allows the controller 106 to specify a color in a particular color space such as XYZ, Yxy, Yu′v′, and RGB.

FIG. 2 depicts a schematic diagram of one embodiment of a color management system controller 106 for a field sequential lighting system. One type of field sequential lighting system is a field sequential lighting display. In particular, FIG. 2 illustrates a more detailed embodiment of the controller 106 shown in FIG. 1. While specific components are shown and described herein, other embodiments of the controller 106 may include fewer or more circuitry and components to implement fewer or more color management operations. Additionally, for convenience and clarity, many conventional features are not shown or described herein, but may be included in specific implementations of the controller 106.

The illustrated controller 106 includes a system controller 114, an interface controller 116, one or more internal registers 118, and a color controller 120. In one embodiment, the system controller 114 performs internal functions such as housekeeping, interfacing between blocks, generating control signals, and so forth. The interface controller 116 is coupled to the system controller 114 and manages communications using known protocols. As one example, the interface controller 116 may be a serial interface controller to manage the I²C communications protocol, although other types of interface protocols may be implemented.

The interface controller 116 is also coupled to the internal registers 118, which are the primary component for configuring the color management system controller 106. In one embodiment, the internal registers 118 include a bank of registers. Each bit within the registers is mapped to a specification, function, or mode of operation. The internal registers 118 also may contain a range of calibration registers, which may be used in a well-known manner.

The color controller 120 is coupled to the internal registers 118, as well as the system controller 114. In one embodiment, control signals are communicated from the system controller 114 to the color controller 120. The color controller 120 contains color processing algorithms that operate on the sensor data from the optical sensor 108. The algorithms correct the PWM output duty factors if there is a mismatch between the desired color and the actual color produced, as measured by the optical sensor 108. The color controller 120 also converts the input color coordinates into an internally understood format. In one embodiment, the default input format is CIE RGB (illuminant E).

In regard to the color processing algorithms, the color controller 120 may implement one or more algorithms, depending on the mode of operation of the color management system controller 106. It is known that the time average brightness of an LED scales linearly with duty factor. If the color of a LED, N, at 100% duty factor is defined by taking its CIE tristimulus values as a vector, as follows:

C_{N}′=i_{N}X+j_{N}Y+k_{N}Z,

Then the color of LED N for other duty factor values, K, can be defined by the following equation:

C_{N}=K_{N}C_{N}′

If light emitted from two LEDs, A and B, are mixed, then the color of the mixed LED light source, M, is given by the following equation:

C_{M}=K_{A}C_{A}′+K_{B}C_{B}′

Further, since the color for LEDs A and B at 100% duty factor are given by:

C_{A}′=i_{A}X+j_{A}Y+k_{A}Z, and

C_{B}′=i_{B}X+j_{B}Y+k_{B}Z,

the equation for the resulting color may be written as:

C_{M}=K_{A}(i_{A}X+j_{A}Y+k_{A}Z)+K_{B}(i_{B}X+j_{B}Y+k_{B}Z),

where K_{A} is the duty factor value for LED A, and K_{B} is the duty factor value for LED B. In one embodiment, the RGB brightness values are adjusted by changing the LED drive current of one or more LEDs 102. Alternatively, the RGB brightness values are adjusted by changing at least one of the PWM signals 110 from the PWM generator 122. It should be noted that duty factor adjustment has a more linear relationship to LED brightness compared to LED drive current adjustment.

Additionally, note that color can alternatively be represented by a three-dimensional vector using standard CIE tristimulus values, since color includes a brightness component and a chromaticity component. Also, while the foregoing description refers to LEDs, similar expressions and equations may be derived for other light sources such as lasers.

In order to implement such control for the LEDs 102, the color management system controller 106 includes a PWM generator 122. The color controller 120 generates PWM output duty factors for each color and communicates the PWM duty factors to the PWM generator 122. The PWM generator 122 receives the duty factor values from the color controller 120 and generates one or more PWM signals 110 according to the duty factor values. For example, the PWM generator 122 may generate a PWM_{R} signal 110 to supply the red LEDs 102, a PWM_{G} signal 110 to supply the green LEDs 102, and a PWM_{B} signal 110 to supply the blue LEDs 102. In this way, the color controller 120 may control each of the PWM signals 110 for each color of LEDs 102.

The illustrated color management system controller 106 also includes a mode select module 124. In one embodiment, the mode select module 124 determines the device operation mode (e.g., normal, sleep, internal/external clock, etc.), as is known in the art.

The illustrated color management system controller 106 also includes an internal oscillator 126. In one embodiment, the internal oscillator 126 generates a clock signal, CLK, for the logic circuits. Alternatively, the generated clock signal, CLK, may be bypassed with an external clock signal 128, selected via a multiplexor 130. Various implementations of clock signals are well-known.

The illustrated color management system controller 106 also includes sensor circuitry 132 coupled to the color controller 120. In one embodiment, the sensor circuitry 132 receives the sensor signals 112 and passes one or more corresponding signals to the color controller 120. For example, the sensor circuitry 132 may receive a SENSE_{X} signal 112, a SENSE_{Y} signal 112, and a SENSE_{Z} signal 112. Although embodiments of the sensor circuitry 132 may include different implementations, one embodiment includes a multiplexor, a programmable amplifier, and an analog-to-digital converter (ADC). The mulitplexor selects one of the incoming sensor signals 112 and passes the selected sensor signal 112 to the programmable amplifier. The gain of the programmable amplifier may be adjusted to boost the sensor signal 112 for further processing. The ADC converts the selected sensor signal 112 from an analog signal to a digital signal, which can be used by the color controller 120. Other embodiments of the sensor circuitry 132 may include other components or configurations. In order for the sensor circuitry 132 to function, in one embodiment, a voltage signal is supplied to the sensor circuitry 132 from a reference voltage, VREF, 134 or an external VREF 136. The internal VREF 134 or external VREF 136 may be selected by a multiplexor 138.

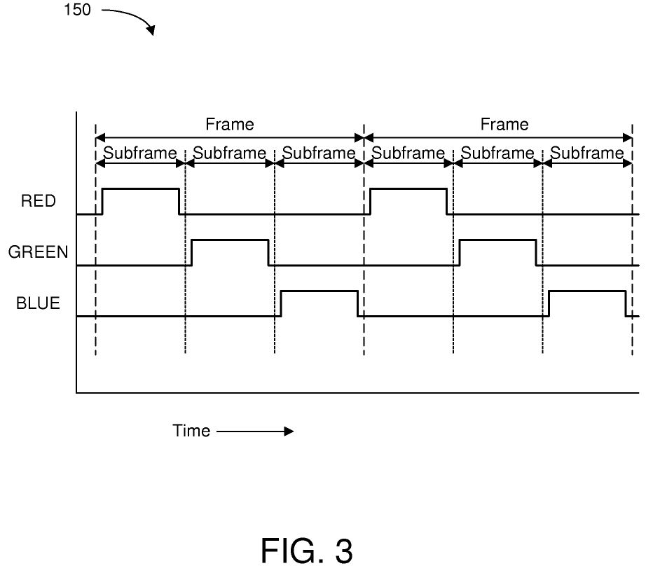

FIG. 3 depicts a wave diagram 150 of LED drive signals to drive LEDs 102 in a temporal sequence for a field sequential lighting system such as a field sequential display or other lighting system. The drive signals are aligned with frames, in which the drive signal for each color is asserted during a corresponding subframe. For example, the drive signal for the red LEDs 102 is asserted during the first subframe. Then, the drive signal for the green LEDs 102 is asserted during the second subframe. Lastly, the drive signal for the blue LEDs 102 is asserted during the third subframe. In this way, the resultant color perceived by a viewer is approximately white if the frame frequency is above a critical frequency at which the viewer in unable to distinguish between the individual RGB colors.

In another embodiment, if only the color red were to be displayed, the drive signal for the red LEDs 102 would be asserted every third subframe, while the drive signals for the green and blue LEDs 102 would not be asserted. In this way, the viewer would see only red. By extension, various resultant colors can be generated by asserted one or more of the drive signals in a similar sequential manner.

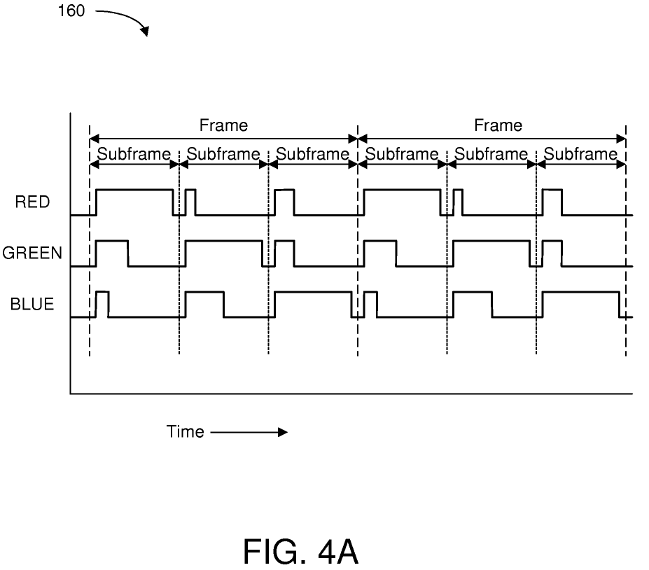

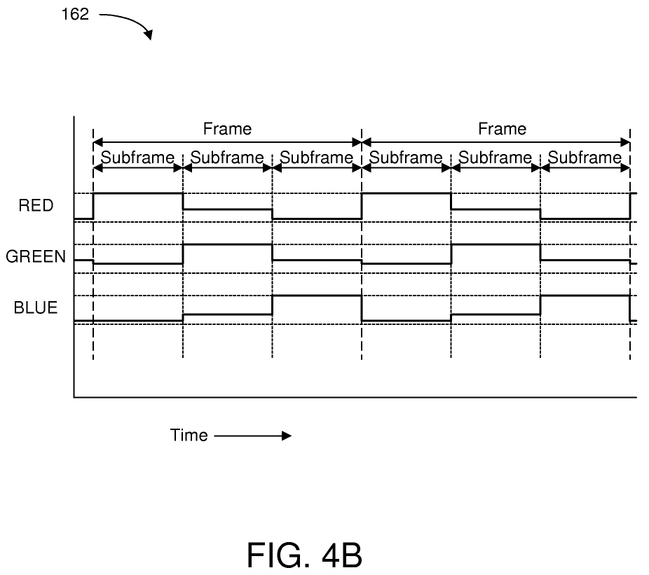

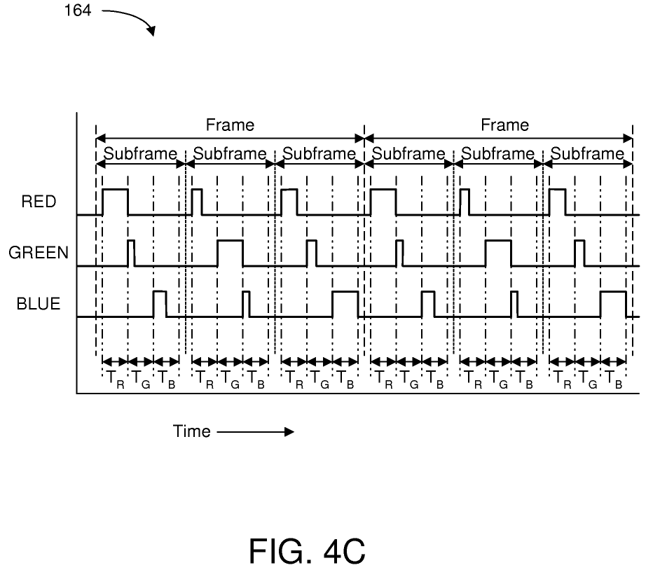

FIG. 4A depicts a wave diagram 160 of LED drive signals to drive LEDs 102 to maintain a color point of a primary color in a field sequential lighting system such as a field sequential display or other lighting system. In particular, the wave diagram 160 corresponds to PWM drive signals. Given that the color point of an LED 102 may shift over time, the assertion of individual colors during each subframe, as described above, may result in a noticeable shift in the color point of each primary color (e.g., RGB). In order to maintain the color point of each primary color, the color controller 120 may utilize data from the sensor circuitry 132 to generate “pseudo” primary colors (also referred to as “pseudo primaries”). A pseudo primary is a primary color that is composed of more than one color LED. It should be noted that the term “primary color” as used herein does not necessarily refer to one of the RGB primary colors, but rather it relates to the colors that are primarily used during each subframe. In this way, any color may be a “pseudo” primary color, if it is the color that is primarily used during one of the individual subframes.

FIG. 4A illustrates the use of “pseudo primaries” to maintain the color point of each primary color used during each subframe. As an example in the RGB color space, the color controller 120 may assert the red drive signal during substantially all of the first subframe. Also during the first subframe, the color controller 120 may assert the green drive signal during a fraction of the first subframe. Additionally, the color controller 120 may assert the blue drive signal during another fraction of the first subframe. In this way, the resultant color during the first subframe is a mixture of the red, green, and blue colors generated in proportion to the corresponding drive signals. In this scenario, the green and blue colors may be denoted as supplemental colors during the first subframe because they are used to supplement the color red. It should be noted that the assertion times of the green and blue LEDs 102 may partially or wholly overlap one another, or they may be temporally disparate. Additionally, it should be noted that in some embodiments the supplemental assertion time of a supplemental color may be greater than the assertion time of the primary color for a given subframe. The resultant pseudo primary color, C_{PR}, for the first subframe may be expressed as:

C_{PR}=K_{R}C_{R}′+K_{G}C_{G}′+K_{B}C_{B}′

where:

C_{R}′=red LED color at 100% duty factor,

C_{G}′=green LED color at 100% duty factor,

C_{B}′=blue LED color at 100% duty factor,

K_{R}=red LED duty factor value,

K_{G}=green LED duty factor value, and

K_{B}=blue LED duty factor value.

Since R, G, and B together define an RGB triangle on the CIE 1931 XY Chart, then C_{PR} is a color point within the RGB triangle. This allows the color controller 120 to maintain the color point of the pseudo primary color, C_{PR}, by adjusting K_{R}, K_{G}, and K_{B} with respect to color shifts in the elemental RGB LEDs 102. In other embodiments, other color processing algorithms may be implemented.

This same technique can be applied to the other two pseudo primaries—pseudo green and pseudo blue—during the second and third subframes. Shifts in these pseudo primaries may be detected by using a tri-color sensor to sample the color of each pseudo primary during its respective subframe. While there are several known optical feedback techniques, some optical feedback techniques are described in detail in U.S. Pat. Nos. 6,894,442 and 6,448,550, which are incorporated by reference herein.

Although the wave diagram 160 illustrates the use of pseudo primaries using RGB LEDs 102, other embodiments may use other color combinations. For example, one embodiment implements pseudo primaries for RGB and white LEDs 102. Another embodiment implements pseudo primaries for RGB and amber LEDs 102. Other color combinations also may be implemented.

Furthermore, although FIG. 4A depicts wave diagrams corresponding to PWM drive signals, other embodiments may use other types of drive signals to drive the LEDs 102. For example, FIG. 4B depicts a wave diagram 162 in which the LED drive signals are LED drive currents. The amplitude of each drive current is modulated within each of the subframes. As another example, FIG. 4C depicts a wave diagram 164 in which the LED drive signals are time-division multiplexed drive signals. Each subframe is divided into multiple segments with each color of light source corresponding to one of the segments. In the depicted embodiment, each subframe is divided into a red segment, T_{R}, a green segment, T_{G}, and a blue segment, T_{B}. The individual drive signals during each segment are manipulated to produce a particular “pseudo primary” color for the subframe.

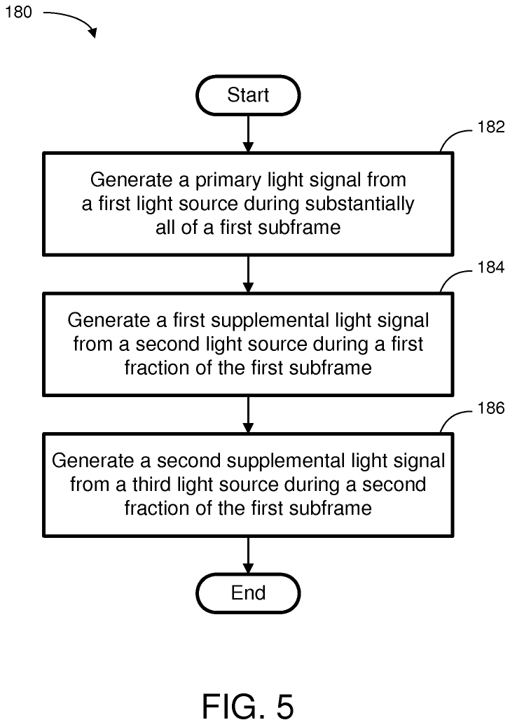

FIG. 5 depicts one embodiment of a color management method 180 to maintain a color point during a subframe for a field sequential lighting system such as a field sequential display or other lighting system. As an example, the color management method 180 may be implemented in conjunction with the color management system 100 of FIG. 1, although the color management method 180 also may be implemented with other color management systems.

At block 182, the color management system 100 generates a primary light signal from a first light source 102 during substantially all of a first subframe. At block 184, the color management system 100 generates a first supplemental light signal from a second light source 102 during a first fraction of the first subframe. At block 186, the color management system 100 generates a second supplemental light signal during a second fraction of the first subframe. In this way, the color management system 100 generates a pseudo primary color including the first primary color (e.g., red) and two supplemental colors (e.g., green and blue). Although the color management method 180 combines three colors to generate the pseudo primary color during the first subframe, other embodiments may combine fewer or more colors to generate other pseudo primary colors. This technique may be applied to generate other pseudo primary colors during subsequent subframes. The depicted method 180 then ends.

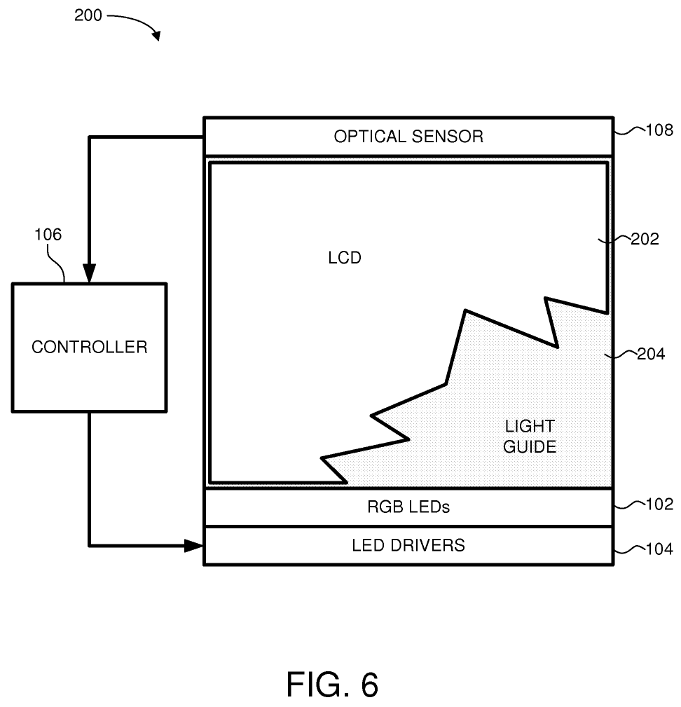

FIG. 6 depicts a schematic diagram of another embodiment of a color management system 200. The depicted color management system 200 includes RGB LEDs 102, LED drivers 104, a controller 106, and an optical sensor 108. Each of these components operates as described above.

The color management system 200 also includes a liquid crystal display (LCD) 202 and a light guide 204. In one embodiment, the light guide 204 facilitates color mixing of the light signals from the RGB LEDs 102. The light mixing may occur in a simultaneous and/or sequential manner. The light guide 204 also functions as a back light to direct at least some of the mixed light toward the LCD 202. In this way, the light from the light guide 204 may be used to display images on the LCD 202.

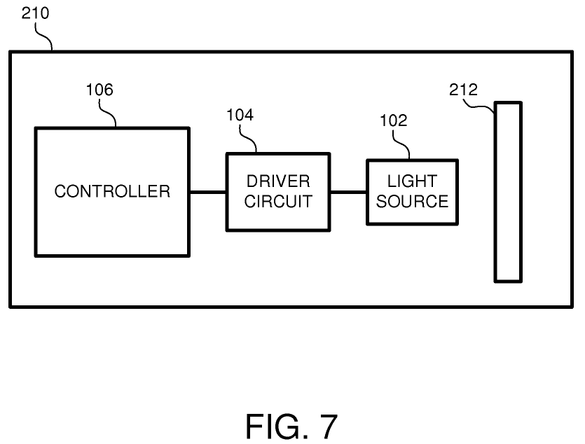

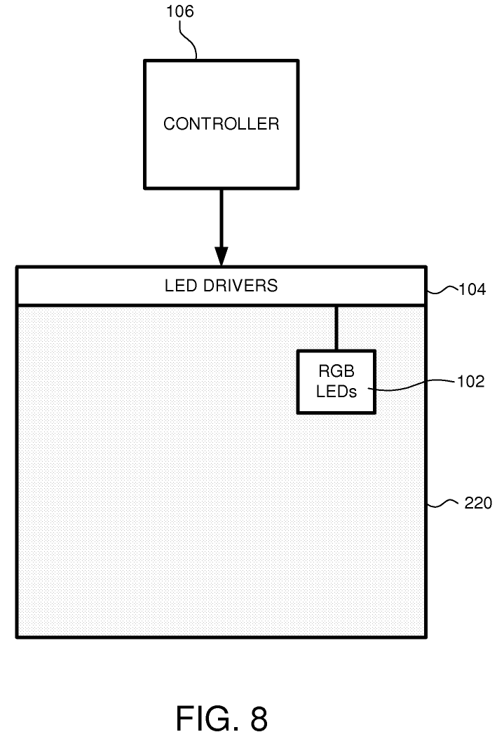

Other embodiments of color management systems also may be implemented. In particular, embodiments may be implemented in any type of lighting system which uses field-sequential lighting, as described above. As one example, some embodiments of video projectors 210, as shown in FIG. 7, may implement field-sequential lighting projection, which would operate similar to the field-sequential LCD described above. In particular, FIG. 7 illustrates a video projector 210 with a controller 106, a driver circuit 104, a light source 102, and an optical lens 212. As another example, solid-state lighting modules for general illumination may implement field-sequential lighting, as described above. In another embodiment, a field-sequential color management system may be implemented for multi-colored LED displays such as RGB LED-based video walls 220, as shown in FIG. 8. In general, LED-based video walls use a cluster of RGB LEDs 102 as a pixel. The LEDs 102 are driven by LED drivers 104, which are controlled by a controller 106, as described above. In one embodiment, each pixel outputs the same pseudo primary during a particular subframe. In order to vary the colors which are displayed, the brightness of each pixel is modulated according to the video data. In other words, the combined color of a pixel during a subframe is the sum of the different colors times their respective duty cycles and modulated brightness. Other embodiments of color management systems may be implemented in other general-purpose and special-purpose lighting applications.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A color management system for a field sequential lighting system, the color management system comprising:
a plurality of light sources;
a driver circuit coupled to the plurality of light sources, the driver circuit to drive the plurality of light sources; and
a controller coupled to the driver circuit, the controller to generate first and second control signals for a first subframe of a temporal sequence of subframes, wherein the first control signal corresponds to a first light source of a first color which is a primary color for the first subframe, and the second control signal corresponds to a second light source of a second color which is a supplemental color for the first subframe.

2. The color management system of claim 1 wherein the driver circuit is configured to generate a first driver signal based on the first control signal to drive the first light source for substantially all of the first subframe, and to generate a second driver signal based on the second control signal to drive the second light source for a fraction of the subframe.

3. The color management system of claim 2 wherein the controller is further configured to generate a third control signal for the first subframe of the temporal sequence of subframes, wherein the third control signal corresponds to a third light source of a third color which is another supplemental color for the first subframe, and wherein the driver circuit is further configured to drive the third light source for less time than the second light source during the first subframe according to the third driver signal.

4. The color management system of claim 2, wherein the first and second driver signals are PWM signals, drive current signals, or time division multiplexed signals.

5. The color management system of claim 1 further comprising a pulse-width-modulated (PWM) signal generator coupled to the controller and the driver circuit, the PWM signal generator to generate first and second PWM signals corresponding to the first and second control signals.

6. The color management system of claim 1 wherein the plurality of light sources comprises a plurality of light emitting diodes, the plurality of light emitting diodes comprising red, blue, and green light emitting diodes.

7. The color management system of claim 6 wherein the plurality of light emitting diodes are integrated into an LED-based video wall.

8. The color management system of claim 1 further comprising an optical sensor coupled to the controller, the optical sensor to sense at least one color component of light generated by the plurality of light sources.

9. The color management system of claim 8 wherein the controller is configured to implement a color processing algorithm to adjust at least one of the first and second control signals based on a sensor signal from the optical sensor.

10. The color management system of claim 8 further comprising a light guide positioned between the plurality of light sources and the optical sensor to facilitate color mixing of the first and second colors from the first and second lights sources.

11. The color management system of claim 10 further comprising a liquid crystal display (LCD) coupled to the light guide, wherein the light guide is configured to operate as a back light for the LCD.

12. The color management system of claim 1 wherein the plurality of light sources are integrated into a field sequential video projector.

13. A color management controller for a field sequential lighting system, the color management controller comprising:
a signal generator circuit to generate a plurality of supply signals for a plurality of light sources having a plurality of colors;
an optical feedback circuit to generate an optical feedback signal based on at least one sensor signal corresponding to at least one of the plurality of colors; and
a control circuit coupled between the signal generator circuit and the optical feedback circuit, the control circuit to implement color mixing of at least two colors of the plurality of colors during each subframe.

14. The color management controller of claim 13 wherein the control circuit is further configured to generate first and second control signals for a first subframe of a temporal sequence of subframes, wherein the first control signal corresponds to a first light source of a first color which is a primary color for the first subframe, and the second control signal corresponds to a second light source of a second color which is a supplemental color for the first subframe.

15. The color management controller of claim 13 wherein the control circuit is configured to implement the color mixing according to a color processing algorithm, as follows:
$${C}_{P} = {\sum }_{i = 1}^{n} {K}_{n} {C}_{n}^{′} ,$$
wherein C_{P} is the mixed color produced by the color mixing during one of the subframes, Kₙ is a duty factor value, and Cₙ′ is a color at 100% duty factor.

16. The color management controller of claim 13 wherein the plurality of supply signals comprises a plurality of PWM signals corresponding to the plurality of light sources.

17. A method for maintaining a constant color point for a color in a field sequential lighting system, the method comprising:
generating a primary light signal from a first light source during substantially all of a first subframe;
generating a first supplemental light signal from a second light source during a first fraction of the first subframe;
generating a second supplemental light signal from a third light source during a second fraction of the first subframe; and
mixing the primary light signal, the first supplemental light signal, and the second supplemental light signal to generate a pseudo-primary color during the first subframe.

18. The method of claim 17 wherein the first, second, and third light sources comprise red, blue, and green light emitting diodes.

19. The method of claim 17 further comprising alternating the first, second, and third light sources as the primary light source and corresponding supplemental light sources during sequential subframes.

20. The method of claim 17 further comprising:
sensing the pseudo-primary color during the first subframe; and
adjusting at least one of the light signals according to a color processing algorithm based on sensing the pseudo-primary color during the first subframe.
